(19) United States
(12) Patent Application Publication
(10) Pub. No.: US 2026/0052564 A1
(43) Pub. Date: Feb. 19, 2026

(54) PPDU FORMAT IN PREEMPTION OPERATION

(71) Applicant: Senscomm Semiconductor Co., Ltd., Suzhou (CN)

(72) Inventors: Sung Jin PARK, Seoul (KR); Daehong KIM, Laguna Hills, CA (US)

(21) Appl. No.: 19/229,378

(22) Filed: Jun. 5, 2025

Related U.S. Application Data
(60) Provisional application No. 63/660,346, filed on Jun. 14, 2024.
(60) Provisional application No. 63/803,373, filed on May 9, 2025.

(30) Foreign Application Priority Data
May 29, 2025 (CN) 202510707487.5

(51) Int. Cl. H04W 74/04; H04W 84/12

(52) U.S. Cl. CPC H04W 74/04; H04W 84/12

(57) ABSTRACT

An access point (AP) for facilitating communication in a wireless network. The AP includes a memory and a processor. The AP obtains a transmission opportunity (TXOP) on a wireless channel. The AP transmits, to a station (STA), a plurality of frames including a first frame and a second frame. The second frame is transmitted after the first frame. The first frame includes a first preamble and the second frame includes a second preamble, the second preamble having a shorter duration than the first preamble.

### CROSS REFERENCE TO RELATED APPLICATION(S)

This application claims benefit of U.S. Provisional Application No. 63/660,346 filed on Jun. 14, 2024; U.S. Provisional Application No. 63/803,373 filed on May 9, 2025, in the United States Patent and Trademark Office; and CN application No. 202510707487.5 filed on May 29, 2025, in the China National Intellectual Property Administration, all of which are hereby incorporated by reference in their entirety.

### TECHNICAL FIELD

This disclosure relates generally to a wireless communication system, and more particularly to, for example, but not limited to, preemption operation in wireless networks.

### BACKGROUND

Wireless local area network (WLAN) devices are widely deployed in diverse environments to provide various communication services such as video, cloud access, broadcasting and offloading. Some of these environments have a lot of access points (AP) stations and non-AP stations in geographically limited areas. The WLAN technology has evolved toward increasing data rates and continues its growth in various markets such as home, enterprise and hotspots over the years since the late 1990s. Recently released standard (IEEE 802.11ax-2021) provides improved network performance in the high-density scenario by adopting OFDMA and MU-MIMO technologies. These improvements can be used to support environments such as outdoor hotspots, dense residential/office area, and stadiums.

The Wi-Fi system has a transmission opportunity (TXOP) sharing framework. The TXOP sharing may allow an access point (AP) station (STA) to allocate time within an obtained TXOP to an associated non-AP STA. The non-AP STA to which time is allocated by the AP may transmit uplink (UL) data without receiving a trigger frame from the AP and may communicate peer-to-peer with other non-AP STAs within the same basic service set (BSS).

However, since the existing TXOP sharing enables the AP to allocate time resources to only one STA, it can limit traffic throughput. Moreover, it is inefficient in terms of channel utilization as it only allocates time without considering the available frequency resources.

The description set forth in the background section should not be assumed to be prior art merely because it is set forth in the background section. The background section may describe aspects or embodiments of the present disclosure.

### SUMMARY

This disclosure may be directed to improvements to a wireless communications system, more particularly to provide a new PPDU format for preemption operation to improve efficiency of preemption operation.

An aspect of the disclosure provides an access point (AP) for facilitating communication in a wireless network. The AP comprises a memory and a processor coupled to the memory. The processor is configured to cause obtaining a transmission opportunity (TXOP) on a wireless channel. The processor is further configured to cause transmitting, to a station (STA), a plurality of frames including a first frame and a second frame. The second frame is transmitted after the first frame. The first frame includes a first preamble and the second frame includes a second preamble. The second preamble has a shorter duration than the first preamble.

In an embodiment, the first preamble includes one or more legacy preamble fields and one or more non-legacy preamble fields. The second preamble includes one or more non-legacy preamble fields.

In an embodiment, the first preamble includes a legacy signal field indicating a duration of the TXOP.

In an embodiment, a time interval between two consecutive frames of the plurality of frames is greater than a short interframe space (SIFS) interval.

In an embodiment, the processor is further configured to cause receiving, from the STA, a request frame indicating a preemption request for transmission of low-latency traffic. The processor is further configured to cause deferring transmission of a frame that is scheduled for transmission to the STA in response to receiving the request frame. The processor is further configured to cause receiving, from the STA, a frame carrying low-latency traffic. The processor is further configured to cause transmitting the deferred frame after reception of the frame carrying the low-latency traffic is completed.

In an embodiment, the deferred frame includes the first preamble.

In an embodiment, the deferred frame includes the second preamble.

In an embodiment, the AP receives the request frame indicating the preemption request after an SIFS interval following transmission of a frame scheduled for transmission prior to the deferred frame and before the transmission of the deferred frame.

An aspect of the disclosure provides an STA for facilitating communication in a wireless network. The STA comprises a memory and a processor coupled to the memory. The processor is configured to cause receiving, from an AP, a plurality of frames including a first frame and a second frame. The second frame is received after the first frame. The first frame includes a first preamble and the second frame includes a second preamble. The second preamble has a shorter duration than the first preamble.

In an embodiment, the first preamble includes one or more legacy preamble fields and one or more non-legacy preamble fields. The second preamble includes one or more non-legacy preamble fields.

In an embodiment, the first preamble includes a legacy signal field indicating a duration of the TXOP.

In an embodiment, a time interval between two consecutive frames of the plurality of frames is greater than an SIFS interval.

In an embodiment, the processor is further configured to cause transmitting, to the AP, a request frame indicating a preemption request for transmission of low-latency traffic. The processor is further configured to cause obtaining a wireless channel which the STA receives the plurality of frames on. The processor is further configured to cause transmitting, to the AP, a frame carrying low-latency traffic. The processor is further configured to cause receiving, from the AP, a deferred frame after the transmission of the frame carrying the low-latency traffic is completed. The deferred frame is scheduled for transmission to the STA and is deferred in response to the request frame.

In an embodiment, the deferred frame includes the first preamble.

In an embodiment, the deferred frame includes the second preamble.

In an embodiment, the STA transmits the request frame indicating the preemption request after an SIFS interval following transmission of a frame scheduled for transmission prior to the deferred frame and before the transmission of the deferred frame.

An aspect of the disclosure provides a method performed by an AP in a wireless network. The method comprises obtaining a TXOP on a wireless channel. The method further comprises transmitting, to an STA, a plurality of frames including a first frame and a second frame. The second frame is transmitted after the first frame. The first frame includes a first preamble and the second frame includes a second preamble. The second preamble has a shorter duration than the first preamble.

In an embodiment, a time interval between two consecutive frames of the plurality of frames is greater than a SIFS interval.

In an embodiment, the method further comprises receiving, from the STA, a request frame indicating a preemption request for transmission of low-latency traffic. The method further comprises deferring transmission of a frame that is scheduled for transmission to the STA in response to receiving the request frame. The method further comprises receiving, from the STA, a frame carrying low-latency traffic. The method further comprises transmitting the deferred frame after reception of the frame carrying the low-latency traffic is completed.

In an embodiment, the AP receives the request frame indicating the preemption request after an SIFS interval following transmission of a frame scheduled for transmission prior to the deferred frame and before the transmission of the deferred frame.

### BRIEF DESCRIPTION OF THE DRAWINGS

FIG. 1 shows a schematic diagram of an example wireless communication network.

FIG. 2 shows an example of a timing diagram of interframe space (IFS) relationships between wireless devices in accordance with an embodiment.

FIG. 3 shows an OFDM symbol and an OFDMA symbol in accordance with an embodiment.

FIG. 4A shows the EHT MU PPDU format in accordance with an embodiment.

FIG. 4B shows the EHT TB PPDU format in accordance with an embodiment.

FIG. 5 shows a block diagram of an electronic device for facilitating wireless communication in accordance with an embodiment.

FIG. 6 shows a schematic diagram of an example of a transmitter in accordance with an embodiment.

FIG. 7 shows a schematic diagram of an example of a receiver in accordance with an embodiment.

FIG. 8 shows an example PPDU transmission in accordance with an embodiment.

FIG. 9 shows another example PPDU transmission in accordance with an embodiment.

FIG. 10 shows another example PPDU transmission in accordance with an embodiment.

FIG. 11 shows another example PPDU transmission in accordance with an embodiment.

FIG. 12 shows another example PPDU transmission in accordance with an embodiment.

FIG. 13 shows another example PPDU transmission in accordance with an embodiment.

FIG. 14 shows an example PPDU format in accordance with an embodiment.

FIG. 15 shows example PPDU formats in accordance with and embodiment.

FIG. 16 shows another example PPDU transmission in accordance with an embodiment.

FIG. 17 shows another example PPDU transmission in accordance with an embodiment.

FIG. 18 shows an example process in accordance with an embodiment.

FIG. 19 shows another example process in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The detailed description set forth below is intended to describe various implementations and is not intended to represent the only implementation. As those skilled in the art would realize, the described implementations may be modified in various different ways, all without departing from the scope of the present disclosure. Accordingly, the drawings and description are to be regarded as illustrative in nature and not restrictive. Like reference numerals designate like elements.

The below detailed description herein has been described with reference to a wireless LAN system according to the Institute of Electrical and Electronics Engineers (IEEE) 802.11 wireless standards including the current and future amendments. However, a person having ordinary skill in the art will readily recognize that the teachings herein are applicable to other network environments, such as cellular telecommunication networks and wired telecommunication networks.

In an embodiment, apparatus or devices such as an AP STA and a non-AP may include one or more hardware and software logic structure for performing one or more of the operations described herein. For example, the apparatuses or devices may include at least one memory unit which stores instructions that may be executed by a hardware processor installed in the apparatus and at least one processor which is configured to perform operations or processes described in the disclosure. The apparatus may also include one or more other hardware or software elements such as a network interface and a display device.

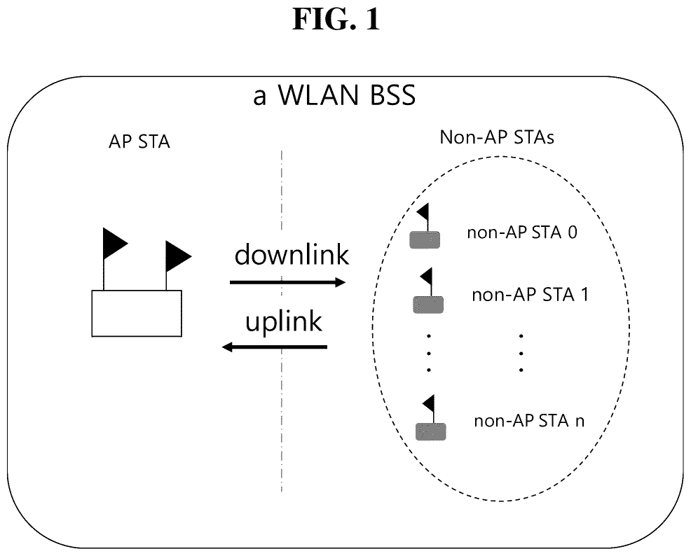

FIG. 1 shows a schematic diagram of an example wireless communication network.

Referring to FIG. 1, a basic service set (BSS) 10 may include a plurality of stations (STAs) including an access point (AP) station (AP STA) 11 and one or more non-AP station (non-AP STA) 12. For convenience, the non-AP STA may be referred to interchangeably as a user or an STA. The STAs may share a same radio frequency channel with one out of WLAN operation bandwidth options (e.g., 20/40/80/160/320 MHz). Hereinafter, in an embodiment, the AP STA and the non-AP STA may be referred as AP and STA, respectively. In an embodiment, the AP STA and the non-AP STA may be collectively referred as station (STA).

The plurality of STAs may participate in multi-user (MU) transmission. In the MU transmission, the AP STA 11 may simultaneously transmit the downlink (DL) frames to the multiple non-AP STAs 12 in the BSS 10 based on different resources and the multiple non-AP STAs 12 may simultaneously transmit the uplink (UL) frames to the AP STA 11 in the BSS 10 based on different resources.

For the MU transmission, multi-user multiple input, multiple output (MU-MIMO) transmission or orthogonal frequency division multiple access (OFDMA) transmission may be used. In MU-MIMO transmission, with one or more antennas, the multiple non-AP STAs 12 may cither simultaneously transmit to the AP STA 11 or simultaneously receive from the AP STA 11 independent data streams over the same subcarriers. Different frequency resources may be used as the different resources in the MU-MIMO transmission. In OFDMA transmission, the multiple non-AP STAs 12 may either simultaneously transmit to the AP STA 11 or simultaneously receive from the AP STA 11 independent data streams over different groups of subcarriers. Different spatial streams may be used as the different resources in MU-MIMO transmission.

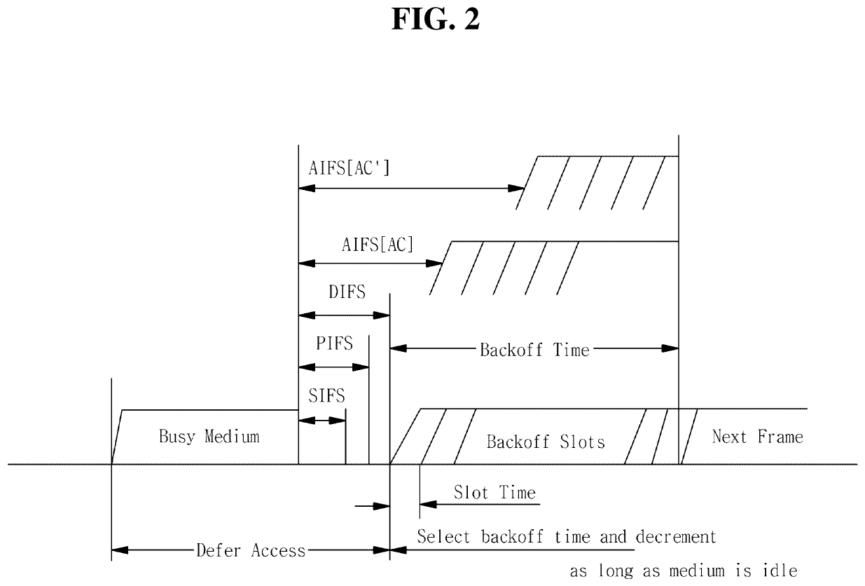

FIG. 2 shows an example of a timing diagram of interframe space (IFS) relationships between stations in accordance with an embodiment.

In particular, FIG. 2 shows a CSMA (carrier sense multiple access)/CA (collision avoidance) based frame transmission procedure for avoiding collision between frames in a channel.

A data frame, a control frame, or a management frame may be exchanged between STAs.

The data frame may be used for transmission of data forwarded to a higher layer. Referring to FIG. 2, access is deferred while the medium is busy until a type of IFS duration has elapsed. The STA may transmit the data frame after performing backoff if a distributed coordination function IFS (DIFS) has elapsed from a time when the medium has been idle.

The management frame may be used for exchanging management information which is not forwarded to the higher layer. Subtype frames of the management frame may include a beacon frame, an association request/response frame, a probe request/response frame, and an authentication request/response frame.

The control frame may be used for controlling access to the medium. Subtype frames of the control frame include a request to send (RTS) frame, a clear to send (CTS) frame, and an acknowledgement (ACK) frame. In the case that the control frame is not a response frame of the other frame, the STA may transmit the control frame after performing backoff if the DIFS has elapsed. If the control frame is the response frame of a previous frame, the WLAN device may transmit the control frame without performing backoff when a short IFS (SIFS) has elapsed. The type and subtype of frame may be identified by a type field and a subtype field in a frame control field.

On the other hand, a Quality of Service (QoS) STA may transmit the frame after performing backoff if an arbitration IFS (AIFS) for access category (AC), i.e., AIFS[AC] has elapsed. In this case, the data frame, the management frame, or the control frame which is not the response frame may use the AIFC[AC].

In an embodiment, a point coordination function (PCF) enabled AP STA may transmit the frame after performing backoff if a PCF IFS (PIFS) has elapsed. The PIFS duration may be less than the DIFS but greater than the SIFS.

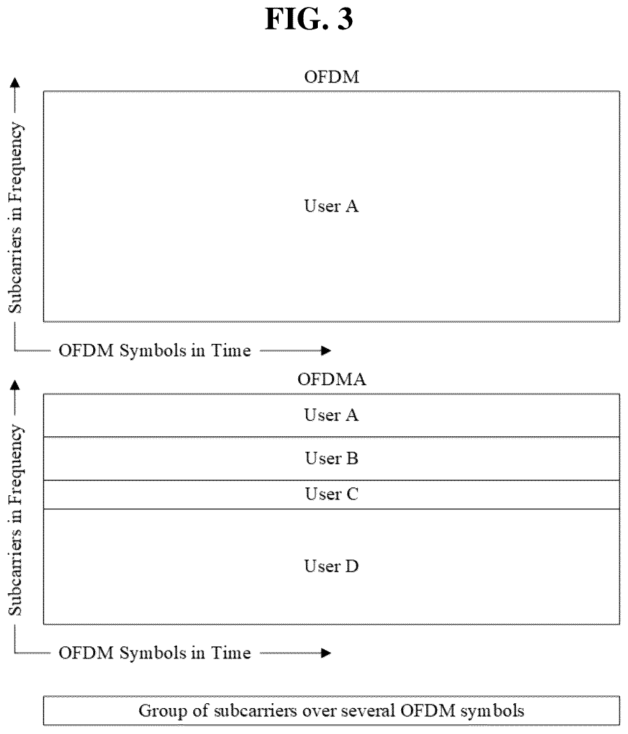

FIG. 3 shows an OFDM symbol and an OFDMA symbol in accordance with an embodiment.

For multi-user access modulation, the orthogonal frequency division multiple access (OFDMA) for uplink and downlink has been introduced in IEEE 802.11ax standard known as High Efficiency (HE) WLAN and will be used in 802.11's future amendments such as EHT (Extreme High Throughput). One or more STAs may be allowed to use one or more resource units (RUs) throughout operation bandwidth to transmit data at the same time. As the minimum granularity, one RU may comprise a group of predefined number of subcarriers and be located at predefined location in orthogonal frequency division multiplexing (OFDM) modulation symbol. Here, non-AP STAs may be associated or non-associated with AP STA when responding simultaneously in the assigned RUs within a specific period such as an SIFS. The SIFS may refer to the time duration from the end of the last symbol, or signal extension if present, of the previous frame to the beginning of the first symbol of the preamble of the subsequent frame.

The OFDMA is an OFDM-based multiple access scheme where different subsets of subcarriers may be allocated to different users, allowing simultaneous data transmission to or from one or more users with high accuracy synchronization for frequency orthogonality. In OFDMA, users may be allocated different subsets of subcarriers which can change from one physical layer (PHY) protocol data unit (PPDU) to the next. In OFDMA, an OFDM symbol is constructed of subcarriers, the number of which is a function of the PPDU bandwidth. The difference between OFDM and OFDMA is illustrated in FIG. 3Error! Reference source not found.

In a case of UL MU transmission, given different STAs with their own capabilities and features, the AP STA may want to have more control mechanism of the medium by using more scheduled access, which may allow more frequent use of OFDMA/MU-MIMO transmissions. PPDUs in UL MU transmission (MU-MIMO or OFDMA) may be sent as a response to the trigger frame sent by the AP. The trigger frame may have STA's information and assign RUs and multiple RUS (MRUs) to STAs. The STA's information in the trigger frame may comprise STA Identification (ID), MCS (modulation and coding scheme), and frame length. The trigger frame may allow an STA to transmit trigger-based (TB) PPDU (e.g., HE TB PPDU or EHT TB PPDU) which is segmented into an RU and all RUs as a response of Trigger frame are allocated to the solicited non-AP STAs accordingly. Hereafter, a single RU and a multiple RU may be referred to as the RU. The multiple RU may include predefined two, three, or more RUs.

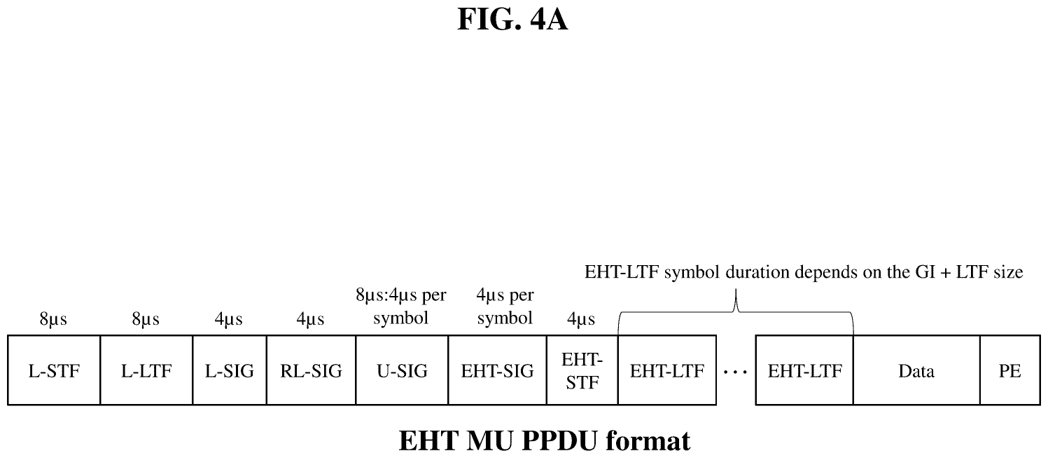

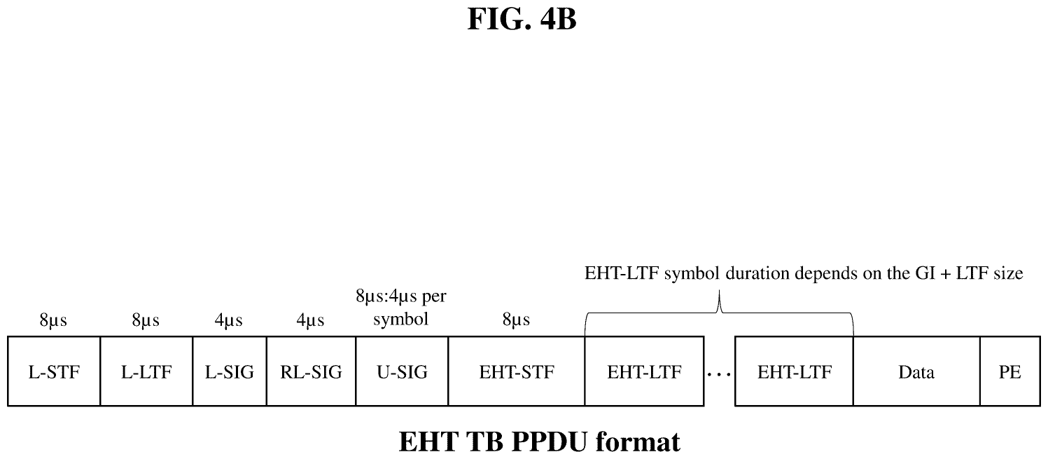

In EHT amendment, two EHT PPDU formats are defined: the EHT MU PPDU and the EHT TB PPDU. Hereinafter, the EHT MU PPDU and the EHT TB PPDU will be described with reference to FIG. 4A and FIG. 4B.

FIG. 4A shows the EHT MU PPDU format in accordance with an embodiment.

The EHT MU PPDU may be used for transmission to one or more users. The EHT MU PPDU is not a response to a triggering frame.

Referring to FIG. 4A, the EHT MU PPDU may include an EHT preamble (hereinafter referred to as a PHY preamble or a preamble), a data field, and a packet extension (PE) field. The EHT preamble may include pre-EHT modulated fields and EHT modulated fields. The pre-EHT modulated fields may include a Non-HT short training field (L-STF), a Non-HT long training field (L-LTF), a Non-HT signal (L-SIG) field, a repeated Non-HT signal (RL-SIG) field, a universal signal (U-SIG) field, and an EHT signal (EHT-SIG) field. The EHT modulated fields may include an EHT short training field (EHT-STF) and an EHT long training field (EHT-LTF). In an embodiment, the L-STF may be immediately followed by the L-LTF immediately followed by the L-SIG field immediately followed by the RL-SIG field immediately followed by the U-SIG field immediately followed by the EHT-SIG field immediately followed by the EHT-STF immediately followed by the EHT-LTF immediately followed by the data field immediately followed by the PE field.

The L-STF field may be utilized for packet detection, automatic gain control (AGC), and coarse frequency-offset correction.

The L-LTF field may be utilized for channel estimation, fine frequency-offset correction, and symbol timing.

The L-SIG field may be used to communicate rate and length information.

The RL-SIG field may be a repeat of the L-SIG field and may be used to differentiate an EHT PPDU from a non-HT PPDU, HT PPDU, and VHT PPDU.

The U-SIG field may carry information necessary to interpret EHT PPDUs.

The EHT-SIG field may provide additional signaling to the U-SIG field for STAs to interpret an EHT MU PPDU. Hereinafter, the U-SIG field, the EHT-SIG field, or both may be referred to as the SIG field.

The EHT-SIG field may include one or more EHT-SIG content channel. Each of the one or more EHT-SIG content channel may include a common field and a user specific field. The common field may include information regarding the resource unit allocation such as the RU assignment to be used in the EHT modulated fields of the PPDU, the RUs allocated for MU-MIMO and the number of users in MU-MIMO allocations. The user specific field may include one or more user fields.

The user field for a non-MU-MIMO allocation may include a STA-ID subfield, a MCS subfield, a NSS subfield, a beamformed subfield, and a coding subfield. The user field for a MU-MIMO allocation may include a STA-ID subfield, a MCS subfield, a coding subfield, and a spatial configuration subfield.

The EHT-STF field may be used to improve automatic gain control estimation in a MIMO transmission.

The EHT-LTF field may enable the receiver to estimate the MIMO channel between the set of constellation mapper outputs and the receive chains.

The data field may carry one or more physical layer convergence procedure (PLCP) service data units (PSDUs).

The PE field may provide additional receive processing time at the end of the EHT MU PPDU.

FIG. 4B shows the EHT TB PPDU format in accordance with an embodiment.

The EHT TB PPDU may be used for a transmission of a response to a triggering frame.

Referring to FIG. 4B, the EHT TB PPDU may include an EHT preamble (hereinafter referred to as a PHY preamble or a preamble), a data field, and a packet extension (PE) field. The EHT preamble may include pre-EHT modulated fields and EHT modulated fields. The pre-EHT modulated fields may include a Non-HT short training field (L-STF), a Non-HT long training field (L-LTF), a Non-HT signal (L-SIG) field, a repeated Non-HT signal (RL-SIG) field, and a universal signal (U-SIG) field. The EHT modulated fields may include an EHT short training field (EHT-STF) and an EHT long training field (EHT-LTF). In an embodiment, the L-STF may be immediately followed by the L-LTF immediately followed by the L-SIG field immediately followed by the RL-SIG field immediately followed by the U-SIG field immediately followed by the EHT-STF immediately followed by the EHT-LTF immediately followed by the data field immediately followed by the PE field. In the EHT TB PPDU, the EHT-SIG field is not present because the trigger frame conveys necessary information and the duration of the EHT_STF field in the EHT TB PPDU is twice the duration of the EHT-STF field in the EHT MU PPDU.

Description for each field in the EHT TB PPDU will be omitted because description for each field in the EHT MU PPDU is applicable to the EHT TB PPDU.

For EHT MU PPDU and EHT TB PPDU, when the EHT modulated fields occupy more than one 20 MHz channels, the pre-EHT modulated fields may be duplicated over multiple 20 MHz channels.

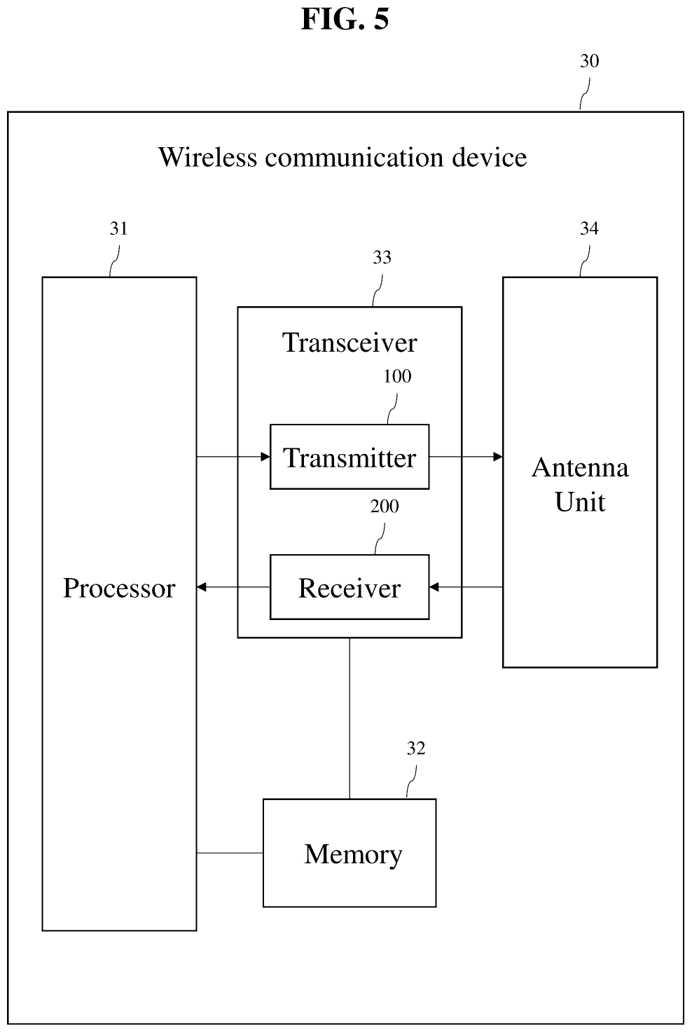

Hereinafter, electronic devices for facilitating wireless communication in accordance with various embodiments will be described with reference to FIG. 5.

FIG. 5 shows a block diagram of an electronic device for facilitating wireless communication in accordance with an embodiment.

Referring to FIG. 5, an electronic device 30 for facilitating wireless communication in accordance with an embodiment may include a processor 31, a memory 32, a transceiver 33, and an antenna unit 34. The transceiver 33 may include a transmitter 100 and a receiver 200.

The processor 31 may perform medium access control (MAC) functions, PHY functions, RF functions, or a combination of some or all of the foregoing. In an embodiment, the processor 31 may comprise some or all of a transmitter 100 and a receiver 200. The processor 31 may be directly or indirectly coupled to the memory 32. In an embodiment, the processor 31 may include one or more processors.

The memory 32 may be non-transitory computer-readable recording medium storing instructions that, when executed by the processor 31, cause the electronic device 30 to perform operations, methods or procedures set forth in the present disclosure. In an embodiment, the memory 32 may store instructions that are needed by one or more of the processor 31, the transceiver 33, and other components of the electronic device 30. The memory may further store an operating system and applications. The memory 32 may comprise, be implemented as, or be included in a read-and-write memory, a read-only memory, a volatile memory, a non-volatile memory, or a combination of some or all of the foregoing.

The antenna unit 34 includes one or more physical antennas. When multiple-input multiple-output (MIMO) or multi-user MIMO (MU-MIMO) is used, the antenna unit 34 may include more than one physical antennas.

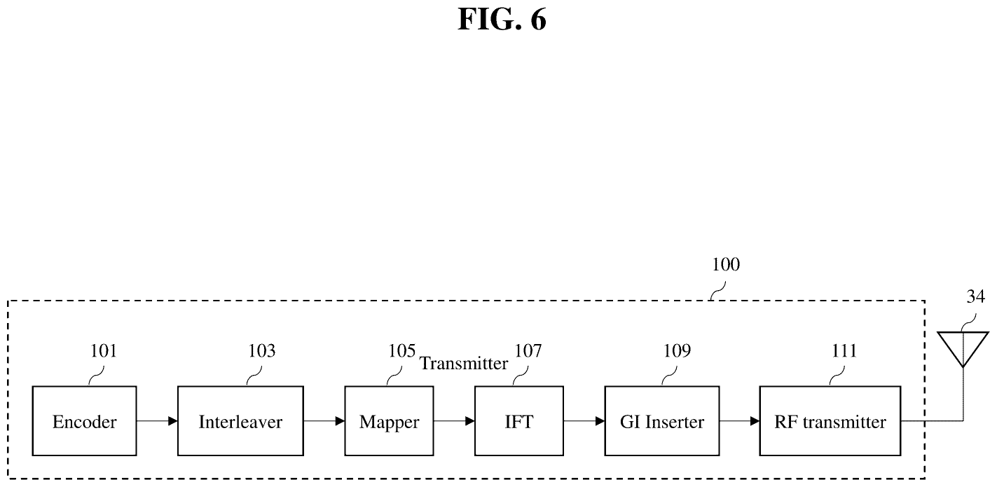

FIG. 6 shows a block diagram of a transmitter in accordance with an embodiment.

Referring to FIG. 6, the transmitter 100 may include an encoder 101, an interleaver 103, a mapper 105, an inverse Fourier transformer (IFT) 107, a guard interval (GI) inserter 109, and an RF transmitter 111.

The encoder 101 may encode input data to generate encoded data. For example, the encoder 101 may be a forward error correction (FEC) encoder. The FEC encoder may include or be implemented as a binary convolutional code (BCC) encoder, or a low-density parity-check (LDPC) encoder.

The interleaver 103 may interleave bits of encoded data from the encoder 101 to change the order of bits, and output interleaved data. In an embodiment, interleaving may be applied when BCC encoding is employed.

The mapper 105 may map interleaved data into constellation points to generate a block of constellation points. If the LDPC encoding is used in the encoder 101, the mapper 105 may further perform LDPC tone mapping instead of the constellation mapping.

The IFT 107 may convert the block of constellation points into a time domain block corresponding to a symbol by using an inverse discrete Fourier transform (IDFT) or an inverse fast Fourier transform (IFFT).

The GI inserter 109 may prepend a GI to the symbol.

The RF transmitter 111 may convert the symbols into an RF signal and transmits the RF signal via the antenna unit 34.

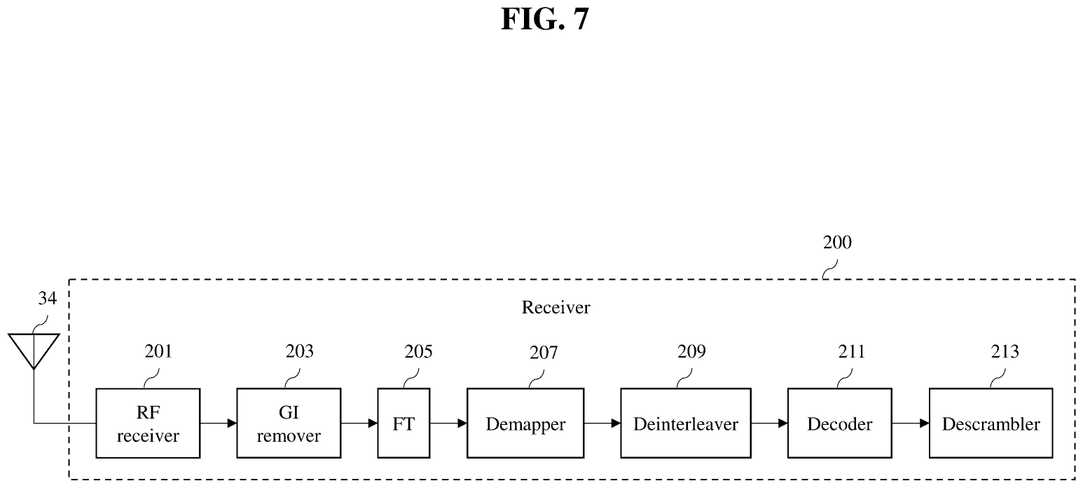

FIG. 7 shows a block diagram of a receiver in accordance with an embodiment.

Referring to FIG. 7, the receiver 200 in accordance with an embodiment may include a RF receiver 201, a GI remover 203, a Fourier transformer (FT) 205, a demapper 207, a deinterleaver 209, a decoder 211, and a descrambler 213.

The RF receiver 201 may receive an RF signal via the antenna unit 34 and converts the RF signal into one or more symbols.

The GI remover 203 may remove the GI from the symbol.

The FT 205 may convert the symbol corresponding a time domain block into a block of constellation points by using a discrete Fourier transform (DFT) or a fast Fourier transform (FFT) depending on implementation.

The demapper 207 may demap the block of constellation points to demapped data bits. If the LDPC encoding is used, the demapper 207 may further perform LDPC tone demapping before the constellation demapping.

The deinterleaver 209 may deinterleave demapped data bits to generate deinterleaved data bits. In an embodiment, deinterleaving may be applied when BCC encoding is used.

The decoder 211 may decode the deinterleaved data bits to generate decoded bits. For example, the decoder 211 may be an FEC decoder. The FEC decoder may include a BCC decoder or an LDPC decoder. In order to support the HARQ procedure, the decoder 211 may combine a retransmitted data with an initial data.

The descrambler 213 may descramble the decoded data bits based on a scrambler seed.

Hereinafter, a multi-link operation (MLO) in accordance with an embodiment will be described.

The IEEE 802.11be Extremely High Throughput (EHT) task group is currently developing the next generation Wi-Fi standard to achieve higher data rate, lower latency, and more reliable connection to enhance user experience. One of the key features of the IEEE 802.11be standard is a multi-link operation (MLO). As most of the AP STAs and the non-AP STAs incorporate dual-band or tri-band capabilities, the newly developed MLO feature may enable packet-level link aggregation in the MAC layer across different PHY links. By performing load balancing according to traffic requirements, the MLO may achieve significantly higher throughput and lower latency for enhanced reliability in a heavily loaded network. With the MLO capability, a multi-link device (MLD) includes multiple affiliated devices to the upper logical link control (LLC) layer, allowing concurrent data transmission and reception in multiple channels across a single or multiple frequency bands in 2.4 GHz, 5 GHZ and 6 GHz.

There exists Wi-Fi technologies that allow a Wi-Fi device to connect to a single link and enable the Wi-Fi device to switch among 2.4 GHz, 5 GHZ and 6 GHz bands. However, such Wi-Fi devices typically have a switching overhead or delay of up to 100 ms. Therefore, the MLO is highly desirable for real-time applications like video calls, wireless VR headsets, cloud gaming and other latency-sensitive applications. The IEEE 802.11be draft specification defines different channel access methods according to two transmission modes: asynchronous and synchronous modes. Under asynchronous transmission mode, the MLD transmits frames asynchronously across multiple links without aligning the starting time. In contrast, in synchronous transmission mode, the starting times are aligned across the links. In either mode, the links may have their own primary channel and parameters, including Packet Protocol Data Unit (PPDU), Modulation and Coding Scheme (MCS), Enhanced Distributed Channel Access (EDCA), etc.

In existing Wi-Fi systems, latency is the delay that a user device experiences when performing a transmission on a busy channel. The channel may be busy due to an influx of traffic where the user device's transmission is backlogged waiting for the other traffic to finish transmission. The delay may also be the result of the user device's transmission having insufficient time to transmit during a transmission opportunity (TXOP) on the channel and having to wait until there is sufficient time on the channel to perform the transmission. Some applications are latency sensitive, where the application relies on the transmission being performed within a certain period of time. Such applications may be referred to as low latency (LL) applications and their latency sensitive transmissions may be referred to as LL traffic.

Preemption operation has been considered as a technique to improve latency and support low latency applications. Preemption operation improves latency by permitting LL traffic to be transmitted as soon as possible even where non-LL traffic is scheduled to be transmitted or the channel is otherwise busy. This disclosure introduces a new PPDU format for use in preemption operation which improves the efficiency of the preemption operation.

In the current WLAN system, an AP or an STA with LL traffic has to wait until the end of a TXOP when the AP or the STA is currently transmitting or receiving non-LL traffic during the TXOP. This may result in LL traffic not being transmitted quickly enough to meet the AP or the STA's latency requirements.

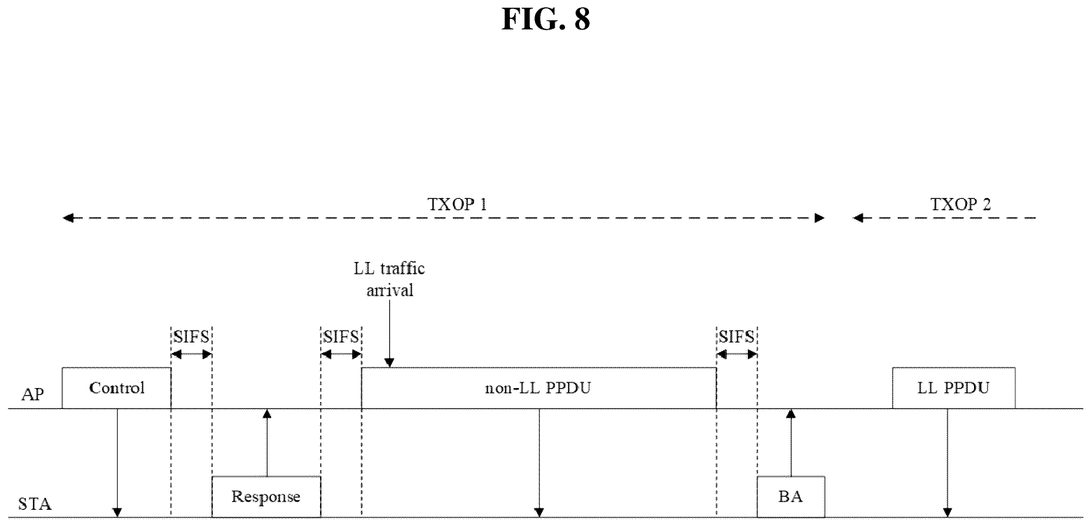

FIG. 8 shows an example PPDU transmission in accordance with an embodiment. The transmission depicted in FIG. 8 is for explanatory and illustration purposes. FIG. 8 does not limit the scope of this disclosure to any particular implementation.

Referring to FIG. 8, an AP has obtained TXOP 1 on the channel and has non-LL traffic. An STA is an LL STA which is capable of transmitting and receiving LL traffic. The AP transmits, to the STA, a Control frame. The Control frame may be a multi-user (MU)-request to send (RTS) frame. In response, after an SIFS interval, the STA transmits, to the AP, a Response frame. The Response frame may be a clear to send (CTS) frame. In response, after an SIFS interval, the AP transmits, to the STA, a non-LL PPDU carrying its non-LL traffic. LL traffic arrives on the AP's buffer shortly after the non-LL PPDU begins transmission and the AP needs to transmit the LL traffic as soon as possible. The AP finishes transmitting the non-LL PPDU with insufficient time remaining in TXOP 1 to transmit the AP's LL PPDU. In response, after an SIFS interval, the STA transmits, to the AP, a block acknowledgment (BA). After TXOP 1 completes, the AP obtains TXOP 2 on the channel. Subsequently, the AP transmits, to the STA, an LL PPDU for its LL traffic using TXOP 2.

In FIG. 8, the AP has LL traffic that arrives in the AP's buffer while the AP is transmitting a PPDU but the AP is unable to transmit the LL traffic until the end of a current TXOP due to the ongoing PPDU transmission. This means that the AP needs to contend for channel access to obtain a subsequent TXOP in order to transmit the LL traffic, resulting in undesired latency.

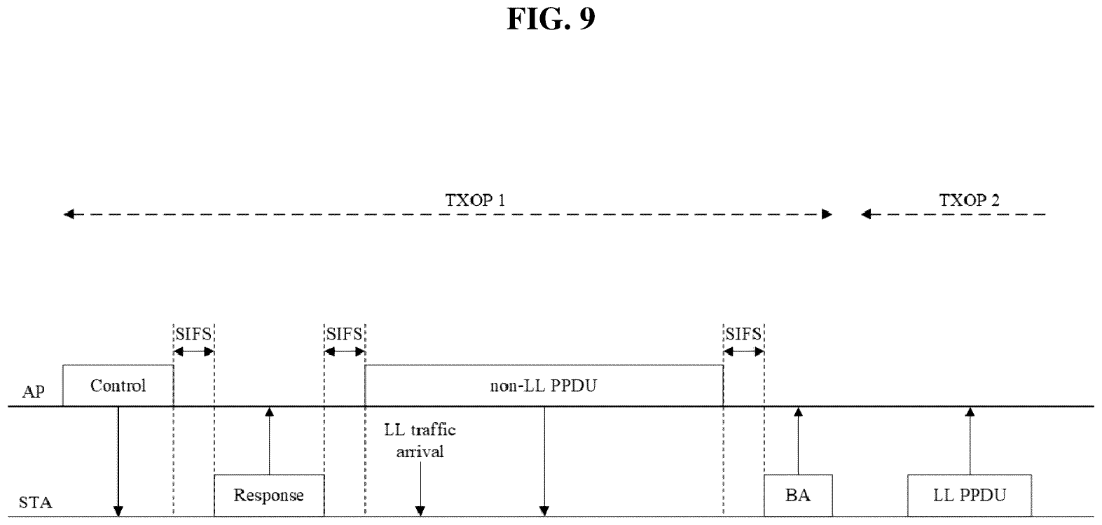

FIG. 9 shows another example PPDU transmission in accordance with an embodiment. The transmission depicted in FIG. 9 is for explanatory and illustration purposes. FIG. 9 does not limit the scope of this disclosure to any particular implementation.

Referring to FIG. 9, an AP has obtained TXOP 1 on the channel and has non-LL traffic. An STA is an LL STA which is capable of transmitting and receiving LL traffic. The AP transmits, to the STA, a Control frame. The Control frame may be a MU-RTS frame. In response, after an SIFS interval, the STA transmits, to the AP, a Response frame. The Response frame may be a CTS frame. In response, after an SIFS interval, the AP transmits, to the STA, a non-LL PPDU carrying its non-LL traffic. LL traffic arrives on the STA's buffer shortly after the non-LL PPDU begins transmission and the STA needs to transmit the LL traffic as soon as possible. The AP finishes transmission of the non-LL PPDU. The STA is unable to transmit an LL PPDU with the remaining duration of TXOP 1 and needs to obtain another TXOP to transmit the STA's LL PPDU. In response, after an SIFS interval, the STA transmits, to the AP, a BA. After TXOP 1 completes, the AP obtains TXOP 2 on the channel. Subsequently, the STA transmits, to the AP, an LL PPDU for its LL traffic using TXOP 2.

In FIG. 9, the STA has LL traffic that arrives in the STA's buffer while the AP is transmitting a PPDU but the STA is unable to transmit the LL traffic until the end of a current TXOP due to the ongoing PPDU transmission. This means that the AP need to contend for channel access to obtain a subsequent TXOP in order to transmit the LL traffic, resulting in undesired latency.

As indicated in the examples of FIGS. 8 and 9, in the current WLAN system, as the length of a PPDU including non-LL becomes longer, the performance latency becomes worse. To avoid this issue, an AP or an STA can divide a large PPDU into several smaller PPDUs with maximum length limitation and time gaps to enable preemption opportunity for a station transmitting LL traffic.

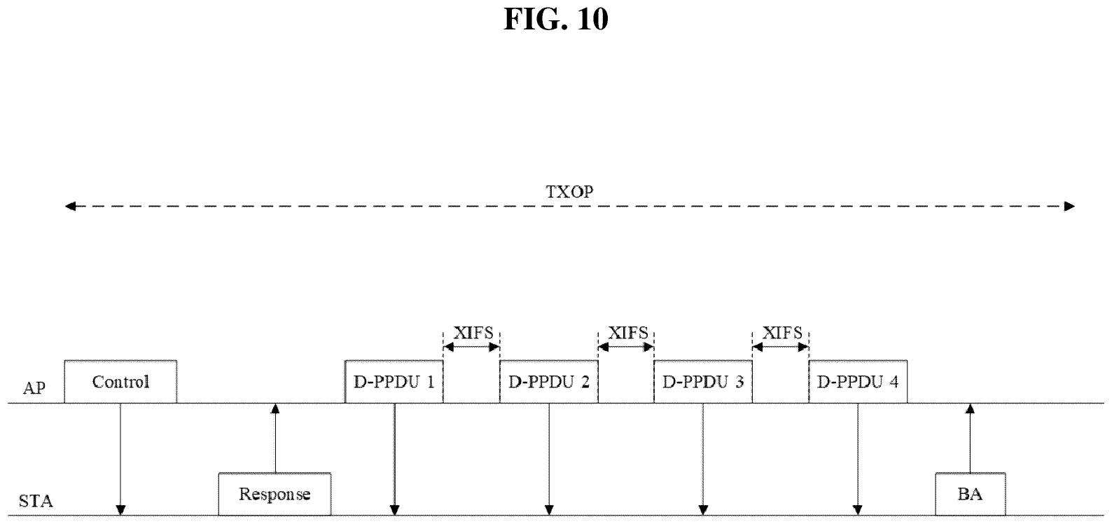

FIG. 10 shows another example PPDU transmission in accordance with an embodiment. The transmission depicted in FIG. 10 is for explanatory and illustration purposes. FIG. 10 does not limit the scope of this disclosure to any particular implementation.

Referring to FIG. 10, an AP has obtained a TXOP on the channel and has non-LL traffic. An STA is an LL STA which is capable of transmitting and receiving LL traffic, and has LL traffic. The AP transmits, to the STA, a Control frame. The Control frame may be a MU-RTS frame. In response, the STA transmits, to the AP, a Response frame. The Response frame may be a CTS frame. Then, the AP transmits, to the STA, a divided (D)-PPDU 1 with a first portion of its non-LL traffic where the D-PPDU 1 is divided from a large PPDU. After a XIFS interval which is an IFS interval longer than an SIFS interval, the AP transmits, to the STA, a D-PPDU 2 with a second portion of its non-LL traffic where the D-PPDU 2 is divided from the large PPDU. After a XIFS interval, the AP transmits, to the STA, a D-PPDU 3 with a third portion of its non-LL traffic where D-PPDU 3 is divided from the large PPDU. After a XIFS interval, the AP transmits, to the STA, a PPDU 4 with a last portion of its non-LL traffic where D-PPDU 4 is divided from the large PPDU. In response, the STA transmits, to the AP, a BA.

In FIG. 10, a large PPDU is divided into multiple smaller D-PPDUs and the transmission intervals XIFS are set to be longer than the SIFS intervals. During the transmission of the multiple smaller D-PPDUs, LL traffic may arrive on the STA's buffer. The STA may have the opportunity to transmit the LL traffic without having to wait until the TXOP ends or the large PPDU transmission is finished as shown in FIGS. 8-9. The STA with LL traffic can transmit the LL traffic during the TXOP by transmitting a preemption request (PR) frame immediately after an SIFS interval before the end of a XIFS interval and then begin contending for the TXOP. The STA may contend for the TXOP after the PR frame by ignoring the network allocation vector (NAV) set by the AP in a previous frame such as a MU-RTS frame or a CTS frame.

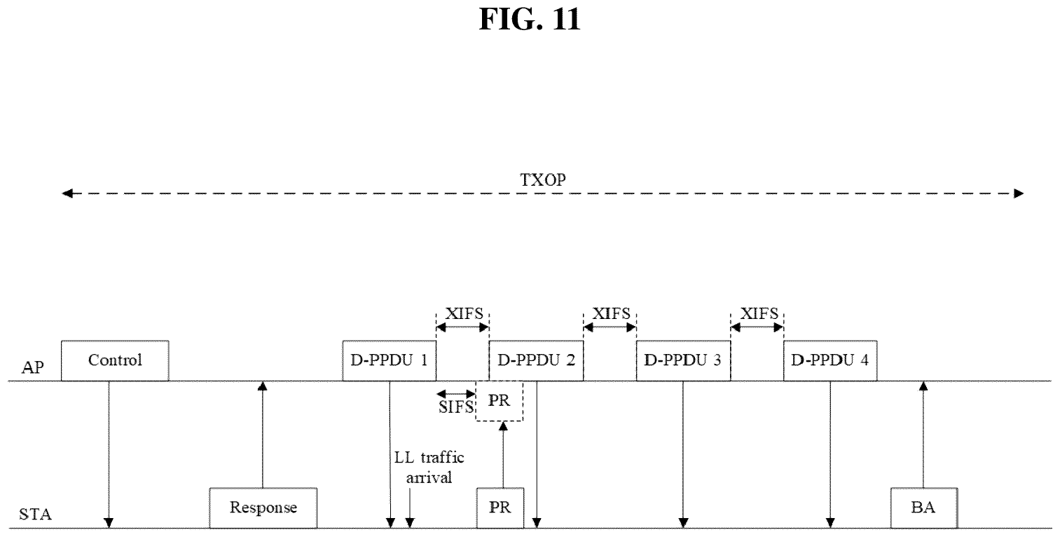

FIG. 11 shows another example PPDU transmission in accordance with an embodiment. The transmission depicted in FIG. 11 is for explanatory and illustration purposes. FIG. 11 does not limit the scope of this disclosure to any particular implementation.

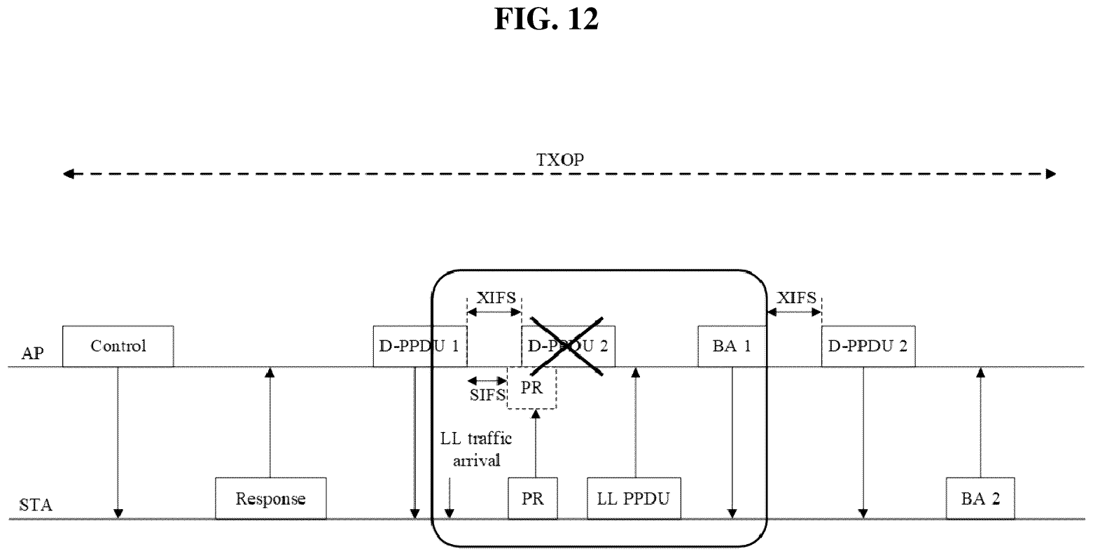

Referring to FIG. 11, an AP has obtained a TXOP on the channel and has non-LL traffic. An STA is an LL STA which is capable of transmitting and receiving LL traffic, and has LL traffic. The AP transmits, to the STA, a Control frame. The Control frame may be a MU-RTS frame. In response, the STA transmits, to the AP, a Response frame. The Response frame may be a CTS frame. Then, the AP transmits, to the STA, a D-PPDU 1 with a first portion of its non-LL traffic where the D-PPDU 1 is divided from a large PPDU. During the D-PPDU 1, the LL traffic arrives on the STA's buffer. After an SIFS interval before the end of a XIFS interval which is an IFS interval longer than an SIFS interval, the STA transmits, to the AP, a PR frame requesting preemption for its LL traffic. In this example of FIG. 11, the AP rejects or ignores the PR and transmits, to the STA, a D-PPDU 2 with a second portion of its non-LL traffic where the D-PPDU 2 is divided from the large PPDU. In some other examples, for example, in FIG. 12, the AP suspends transmitting the D-PPDUs and provides the STA with an opportunity to send the LL traffic. Subsequently, after a XIFS interval, the AP transmits, to the STA, a D-PPDU 3 with a third portion of its non-LL traffic where D-PPDU 3 is divided from the large PPDU. Subsequently, after a XIFS interval, the AP transmits, to the STA, a PPDU 4 with a last portion of its non-LL traffic where D-PPDU 4 is divided from the large PPDU. In response, the STA transmits, to the AP, a BA.

In FIG. 11, if LL traffic arrives on the STA's buffer while the STA receives the D-PPDU 1, the STA can transmit a PR frame to the AP before the D-PPDU 2 is transmitted. Upon receiving the PR frame, the AP which doesn't reject the PR will prepare to receive the LL traffic that the STA intends to transmit instead of transmitting the second D-PPDU, as shown in FIG. 12.

FIG. 12 shows another example PPDU transmission in accordance with an embodiment. The transmission depicted in FIG. 12 is for explanatory and illustration purposes. FIG. 12 does not limit the scope of this disclosure to any particular implementation.

Referring to FIG. 12, an AP has obtained a TXOP on the channel and has non-LL traffic. An STA is an LL STA which is capable of transmitting and receiving LL traffic, and has LL traffic. The AP transmits, to the STA, a Control frame. The Control frame may be a MU-RTS frame. In response, the STA transmits, to the AP, a Response frame. The Response frame may be a CTS frame. Then, the AP transmits, to the STA, a D-PPDU 1 with a first portion of its non-LL traffic where the D-PPDU 1 is divided from a large PPDU. During the D-PPDU 1, the LL traffic arrives on the STA's buffer. After an SIFS interval before the end of a XIFS interval which is an IFS interval longer than an SIFS interval, the STA transmits, to the AP, a PR frame requesting preemption for its LL traffic. In response, the AP does not transmit a D-PPDU 2 and prepares to receive the STA's LL traffic. Subsequently, the STA transmits, to the AP, an LL PPDU after successfully contending for the channel. In response, the AP transmits, to the STA, a BA 1. Subsequently, a XIFS interval after the BA 1, the AP transmits, to the STA, the D-PPDU 2 with a last portion of its non-LL traffic where the D-PPDU 2 is divided from the large PPDU. In response, the STA transmits, to the AP, a BA 2.

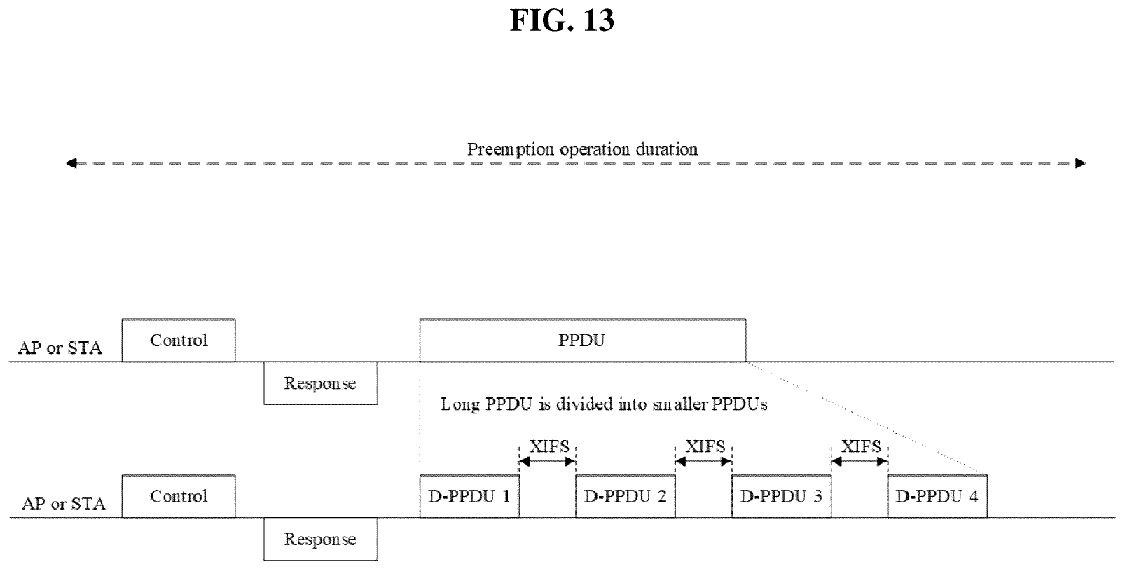

In efficient preemption operation, a large PPDU that was originally intended to be transmitted in a single PPDU is divided into multiple PPDUs (D-PPDUs) for transmission as shown in FIG. 13.

FIG. 13 shows another example PPDU transmission in accordance with an embodiment. The transmission depicted in FIG. 13 is for explanatory and illustration purposes. FIG. 13 does not limit the scope of this disclosure to any particular implementation.

Referring to FIG. 13, an AP or an STA has obtained a TXOP on the channel and has non-LL traffic. The AP or the STA transmits a Control frame. The Control frame may be a MU-RTS frame. Subsequently, the AP or the STA receives a Response frame. The Response frame may be a CTS frame. Then, the AP or the STA transmits a PPDU. Instead of transmitting a long PPDU as shown on top section of FIG. 13, the AP or the STA transmits a D-PPDU 1 with a first portion of its non-LL traffic where the D-PPDU 1 is divided from the PPDU. Subsequently, a XIFS interval after the D-PPDU 1, the AP or the STA transmits a D-PPDU 2 with a second portion of its non-LL traffic where the D-PPDU 2 is divided from the PPDU. Subsequently, a XIFS interval after the D-PPDU 2, the AP or the STA transmits a D-PPDU 3 with a third portion of its non-LL traffic where the D-PPDU 3 is divided from the PPDU. Subsequently, a XIFS interval after the D-PPDU 3, the AP or the STA transmits a D-PPDU 4 with a last portion of its non-LL traffic where the D-PPDU 4 is divided from the PPDU. In an embodiment, the AP or the STA may be preempted during the XIFS intervals between any the two consecutive D-PPDUs.

In FIG. 13, the long PPDU is divided into multiple D-PPDUs for transmission which allows for preemption during the transmission of the non-LL traffic of the AP or the STA, but issues accompany this efficient preemption operation. The long PPDU includes a preamble. Each D-PPDU is transmitted with its own preamble, so while the long PPDU will have only one preamble, the D-PPDUs will each have a preamble, thereby increasing the total cost of resources to perform the transmission.

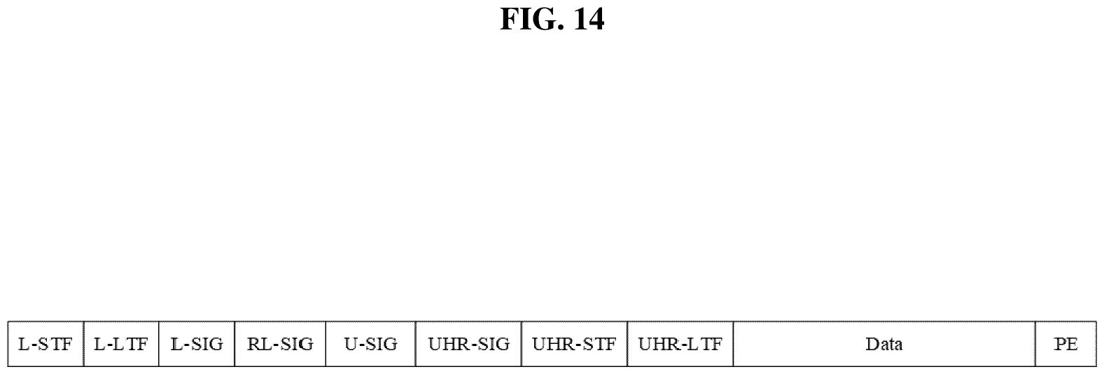

FIG. 14 shows an example PPDU format in accordance with an embodiment. The format depicted in FIG. 14 is for explanatory and illustration purposes. FIG. 14 does not limit the scope of this disclosure to any particular implementation.

Referring to FIG. 14, a PPDU format comprises a preamble, a data field, and a PE field. The preamble comprises an L-STF, an L-LTF, an L-SIG field, an RL-SIG field, a U-SIG field, an ultra-high reliability (UHR)-SIG field, a UHR-STF and a UHR-LTF. The L-STF, the L-LTF, the L-SIG field, the RL-SIG field, the U-SIG field, the data field and the PE field are defined as in FIG. 4A.

The UHR-SIG field may provide additional signaling to the U-SIG field for STAs to interpret an UHR MU PPDU. Hereinafter, the U-SIG field, the UHR-SIG field, or both may be referred to as the SIG field.

The UHR-STF may be used to improve automatic gain control estimation in a MIMO transmission.

The UHR-LTF may enable the receiver to estimate the MIMO channel between the set of constellation mapper outputs and the receive chains.

In FIG. 14, the preamble includes a legacy part and a non-legacy part. The legacy part of the preamble includes the L-STF, the L-LTF, the L-SIG field and the RL-SIG field, while the non-legacy part of the preamble includes the U-SIG field, the UHR-SIG field, the UHR-STF and the UHR-LTF. If each D-PPDU includes the legacy part of the preamble as shown in FIG. 14, the overheard increase in cost of transmitting the same amount of data of a single PPDU would be substantial when compared to the overhead cost of transmitting the data in the single PPDU. This substantial increase in overhead costs results in decreased efficiency because without preemption operation necessitating the transmission of multiple D-PPDUs, only the single PPDU including a single preamble would be transmitted.

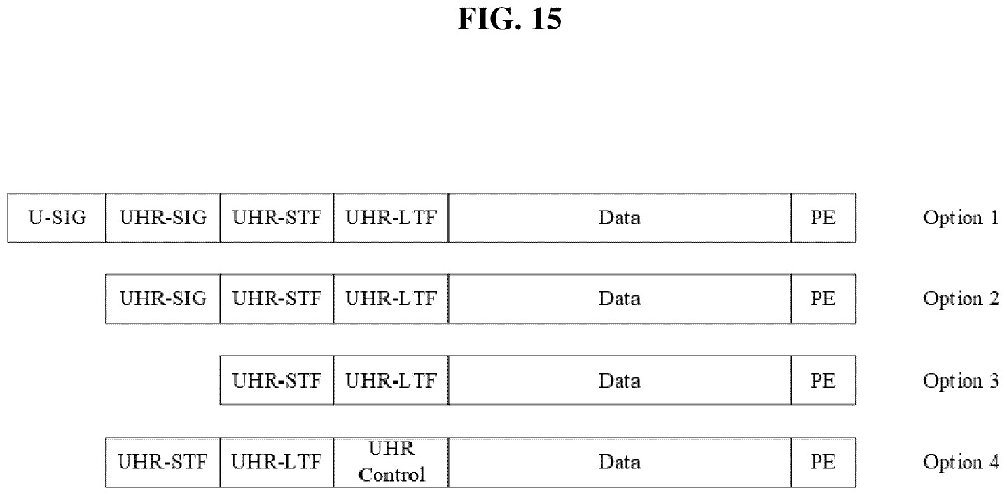

In an embodiment, each D-PPDU may use a PPDU format including a reduced preamble so that the PPDU format does not include the legacy part of the preamble as shown in FIG. 15.

FIG. 15 shows another example PPDU format in accordance with an embodiment. The format depicted in FIG. 15 is for explanatory and illustration purposes. FIG. 15 does not limit the scope of this disclosure to any particular implementation.

Referring to FIG. 15, option 1, option 2, option 3 and option 4 represent four different PPDU formats that reduce overhead cost of transmitting a D-PPDU by not including the legacy part, the legacy preamble fields, of the preamble. The PPDU of option 1, option 2, option 3 and option 4 includes a preamble, a data field and a PE field.

The preamble of option 1 includes a U-SIG field, a UHR-SIG field, a UHR-STF and UHR-LTF.

The preamble of option 2 includes a UHR-SIG field, a UHR-STF, and a UHR-LTF.

The preamble of option 3 includes a UHR-STF and a UHR-LTF.

The preamble of option 4 includes a UHR-STF, a UHR-LTF and a UHR Control field.

The U-SIG field, the UHR SIG field, the UHR-STF, UHR-LTF, data field and PE field are as defined above. The UHR Control field includes signaling control information such as MCS, length and other necessary details to decode the data field.

The PPDU formats listed above do not include the legacy part of the preamble shown in FIG. 14 resulting in PPDUs with reduced preambles which minimizes the overhead costs while preserving the preemption operation.

In an embodiment, an AP or an STA may decide to initiate a preemption operation due to the potential for LL traffic during the transmission of a large PPDU. The AP may divide the large PPDU into multiple smaller D-PPDUs where at least one D-PPDU is structured with the same preamble as the large PPDU, such as with the PPDU format of FIG. 14, and at least one D-PPDU is structured with a minimized preamble, such as one of the PPDU formats of FIG. 15. During transmission of the D-PPDUs, if LL traffic is generated at the STA, the STA may transmit, to the AP, a PR frame. In response, the AP prepares to receive the LL traffic from the STA instead of continuing with the transmission of the D-PPDUs. Subsequently, after winning contention for the channel, the STA transmits, to the AP, the PPDU including the LL traffic. In response, the AP transmits, to the STA, a BA acknowledging reception of the LL traffic. Subsequently, the AP resumes transmission of the remaining D-PPDUs, ensuring the completion of the original large PPDU transmission. In an embodiment, during the transmission of the D-PPDUs, if LL traffic is generated at the AP, the AP may transmit, to the STA, a PPDU including the LL traffic instead of continuing with the transmission of the D-PPDUs. In response, the STA transmits, to the AP, a BA acknowledging reception of the LL traffic. Subsequently, the AP resumes transmission of the remaining D-PPDUs, ensuring the completion of the original large PPDU transmission.

The preemption operations described above optimize the utilization of the channel by allowing for the interruption and resumption of data transmission to accommodate LL traffic efficiently even where the data transmission is a large PPDU.

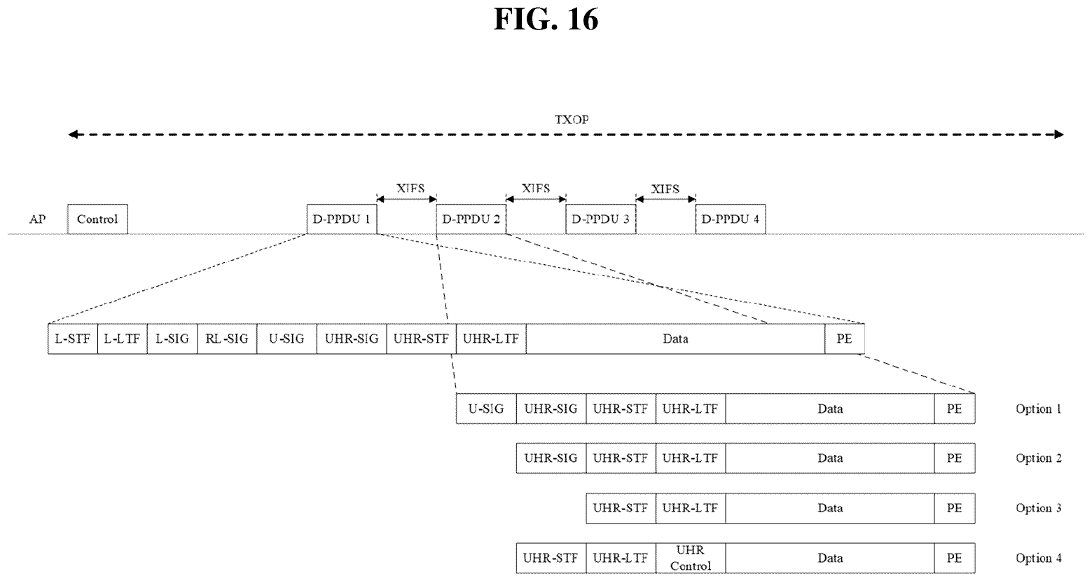

FIG. 16 shows another example PPDU transmission in accordance with an embodiment. The transmission depicted in FIG. 16 is for explanatory and illustration purposes. FIG. 16 does not limit the scope of this disclosure to any particular implementation.

Referring to FIG. 16, an AP has obtained a TXOP on the channel and has non-LL traffic. The AP transmits a Control frame. The Control frame may be MU-RTS frame. The AP divides a large PPDU to generate a D-PPDU 1, a D-PPDU 2, a D-PPDU 3 and a D-PPDU 4. The D-PPDU 1 includes a first portion of the large PPDU, the D-PPDU 2 includes a second portion of the large PPDU, the D-PPDU 3 includes a third portion of the large PPDU and the D-PPDU 4 includes a last portion of the large PPDU. The AP transmits the D-PPDU 1. The D-PPDU 1 is structured in the PPDU format of FIG. 14, including legacy preamble fields. The legacy preamble fields include an L-STF, an L-LTF, an L-SIG field and an RL-SIG field. The D-PPDU 1 is decodable by legacy STAs based on the L-STF and the L-LTF. The L-SIG field and the RL-SIG field indicate to legacy STAs that the AP is busy performing transmissions for a period of time. The period of time can be the TXOP duration or the preemption duration. The legacy STAs that receive the D-PPDU 1 are aware of the transmissions and know to avoid interfering with the AP's transmissions during that period of time. Subsequently, after a XIFS interval, the AP transmits the D-PPDU 2, the D-PPDU 3 and the D-PPDU 4 in succession followed by a XIFS interval for each transmission. The D-PPDU 2, the D-PPDU 3 and the D-PPDU 4 are structured in one of the PPDU formats of FIG. 15.

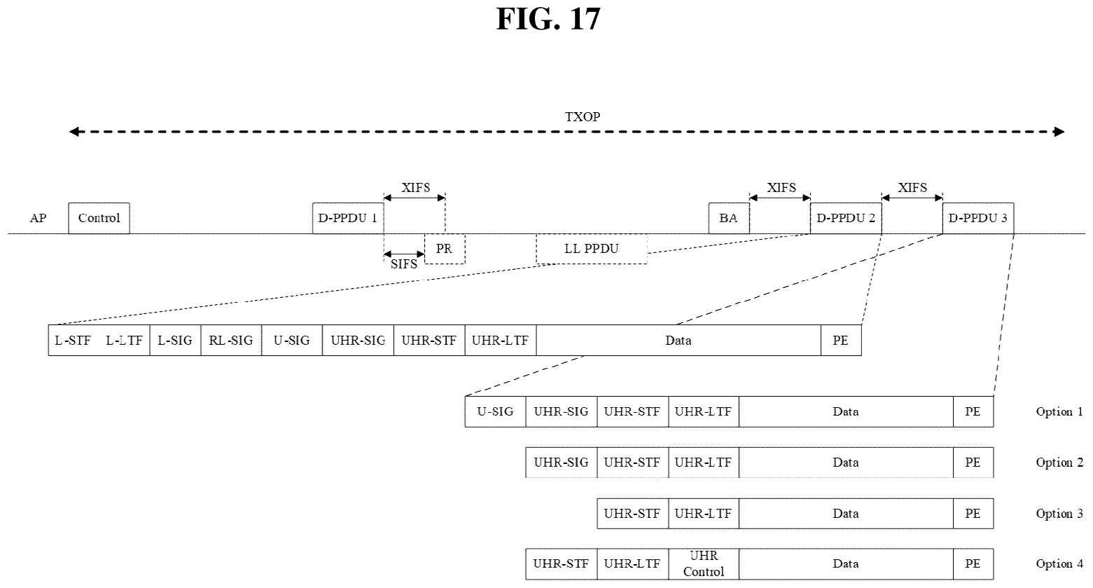

In an embodiment, if the AP receives a PR frame before the end of a XIFS interval, the preemption operation is as shown in FIG. 17.

FIG. 17 shows another example PPDU transmission in accordance with an embodiment. The transmission depicted in FIG. 17 is for explanatory and illustration purposes. FIG. 17 does not limit the scope of this disclosure to any particular implementation.

Referring to FIG. 17, an AP has obtained a TXOP on the channel and has non-LL traffic. The AP transmits a Control frame. The Control frame may be MU-RTS frame. The AP divides a large PPDU to generate a D-PPDU 1, a D-PPDU 2 and a D-PPDU 3. The AP transmits the D-PPDU 1. The D-PPDU 1 is structured in the PPDU format of FIG. 14, including legacy preamble fields. The legacy preamble fields include an L-STF, an L-LTF, an L-SIG field and an RL-SIG field. The D-PPDU 1 is decodable by legacy STAs based on the L-STF and the L-LTF. The L-SIG field and the RL-SIG field indicate to legacy STAs that the AP is busy performing transmissions for a period of time. The period of time can be the TXOP duration or the preemption duration. The legacy STAs that receive the D-PPDU 1 are aware of the transmissions and know to avoid interfering with the AP's transmissions during that period of time. Before the end of a XIFS interval and after an SIFS interval, the AP receives a PR frame requesting preemption for LL traffic. In response, the AP avoids transmitting the D-PPDU 2 until the preemption is complete. Subsequently, the AP receives an LL PPDU including the LL traffic. In response, the AP transmits a BA acknowledging the LL PPDU. Subsequently, after a XIFS interval, the AP transmits the D-PPDU 2. The D-PPDU 2 is structured with the same PPDU format as the D-PPDU 1, including legacy preamble fields. The legacy preamble fields include the L-STF, the L-LTF, the L-SIG field and the RL-SIG field. The D-PPDU 2 is decodable by legacy STAs based on the L-STF and the L-LTF. The L-SIG field and the RL-SIG field indicate to legacy STAs that the AP is busy performing transmissions for an updated period of time. The period of time can be the TXOP duration or the preemption duration. The legacy STAs that receive the D-PPDU 2 are aware of the transmissions and know to avoid interfering with the AP's transmissions during that updated period of time. Subsequently, after a XIFS interval, the AP transmits the D-PPDU 3. The D-PPDU 3 is structured with one of the PPDU formats of FIG. 15.

In FIG. 17, the D-PPDU 2 ensures that the interruption of the transmission of D-PPDUs and the AP's acknowledgement of the LL PPDU are handled efficiently because it updates the period of time that the legacy STAs are to know to avoid interrupting the AP when the AP is busy performing transmissions for the updated period of time. The D-PPDU 3 is structured with one of the PPDU formats of FIG. 15 to optimize efficiency and reduce the overhead during continuous transmission, transmission of a sequence of D-PPDUs uninterrupted by preemption.

An AP or an STA that receives a PPDU requires training sequences, such as an L-STF and an L-LTF, to successfully decode SIG fields such as an L-SIG field, an RL-SIG field, a U-SIG field, and a UHR-SIG field. In an embodiment, the L-STF and the L-LTF are excluded to reduce the overhead when using D-PPDU. The AP or STA that receives the D-PPDU with the reduced preamble may need the L-STF and the L-LTF to successfully decode SIG fields in the reduced preamble.

In option 1 of FIG. 15, the PPDU format includes a preamble, a data field, and a PE field. The preamble comprises a U-SIG field, a UHR-SIG field, a UHR-STF and a UHR-LTF. Notably the PPDU format does not include legacy preamble fields, such as an L-STF, an L-LTF, an L-SIG field, or an RL-SIG field. When an AP or an STA receives the option 1 PPDU format during the preemption operation described above, the AP or the STA requires the fields composed of training sequences. For example, the AP requires the L-STF and the L-LTF to decode the U-SIG field and the UHR-SIG field. In an embodiment, the AP or the STA may receive a D-PPDU 1 that is structured with the PPDU format of FIG. 14, including the L-STF and the L-LTF. The D-PPDU 1 ensures backwards compatibility by allowing any AP or STA that receives the D-PPDU 1 to decode the initial SIG fields. For example, a legacy STA that receives D-PPDU 1 can at least decode the initial SIG fields of the D-PPDU 1, such as the L-SIG and the RL-SIG using the L-STF and the L-LTF. Accordingly, subsequent D-PPDUs, such as D-PPDU 2, structured with the PPDU format of option 1 can reuse the L-STF and the L-LTF from the D-PPDU 1 to decode the U-SIG and UHR-SIG of the subsequent D-PPDUs. This reuse of the training sequences of the L-STF and the L-LTF allows for subsequent D-PPDUs to exclude the legacy preamble fields from the preamble of those D-PPDUs, reducing the overhead costs and increasing efficiency of the preemption operation.

In option 2 of FIG. 15, the PPDU format includes a preamble, a data field, and a PE field. The preamble comprises a UHR-SIG field, a UHR-STF and a UHR-LTF. Notably the PPDU format does not include an L-STF, an L-LTF, an L-SIG field, an RL-SIG field or a U-SIG field. The SIG field of the option 1 PPDU format are effectively consolidated into the UHR-SIG field of the option 2 PPDU format. The option 2 PPDU format shares the remaining characteristics of the option 1 PPDU format.

In option 3 of FIG. 15, the PPDU format includes a preamble, a data field, and a PE field. The preamble comprises a UHR-STF and a UHR-LTF. Notably, the PPDU format does not include an L-STF, an L-LTF, an L-SIG field, an RL-SIG field, an USIG field or an UHR-SIG field. An AP or an STA that received a D-PPDU 1 structured with the PPDU format of FIG. 14 and subsequent D-PPDUs, such as D-PPDU 2, structured with the option 3 PPDU format do not reuse the training sequences of an L-STF and an L-LTF included in the D-PPDU 1. The AP or the STA instead uses the UHR-STF and the UHR-LTF to decode the data fields of the subsequent D-PPDUs. The AP or the STA may require control information used by an encoding data field to be able to decode the data fields. The control information is signaled either in previously transmitted control frames or the D-PPDU 1.

In option 4 of FIG. 15, the PPDU format includes a preamble, a data field, and a PE field. The preamble comprises a UHR-STF, a UHR-LTF and a UHR Control field. Notably, the PPDU format does not include an L-STF, an L-LTF, an L-SIG field, an RL-SIG field, a U-SIG field or an UHR-SIG field. An AP or an STA that received a D-PPDU 1 structured with the PPDU format of FIG. 14 and subsequent D-PPDUs, such as D-PPDU 2, structured with the option 3 PPDU format do not reuse the training sequences of a L-STF and a L-LTF included in the D-PPDU 1. The AP or the STA instead uses the UHR-STF and the UHR-LTF to decode the data fields of the subsequent D-PPDUs. The AP or the STA may require control information to decode the data fields. The AP or the STA uses the control information, such as Modulation and Coding Scheme (MCS), Length, and other necessary details, included in the UHR Control field to decode the data field. The AP or the STA that receives a D-PPDU structured with the option 4 PPDU format decodes the data field based on the control information of the UHR-Control field and does not rely on previous control frames or D-PPDU1. Additionally, use of the option 4 PPDU format makes possible flexible encoding of the data field.

In an embodiment, the type of PPDU format used may be dynamically indicated, for example that a D-PPDU 2 is of a PPDU format of option 1. A D-PPDU 1 with the structure of the PPDU format of FIG. 14 may be modified to include a 1-bit indicator in the SIG and MAC fields. This indicator signals that the subsequent D-PPDUs will use a PPDU format, for example option 1. An AP or an STA treat the D-PPDU 1 as a non-divided PPDU without the expectation of subsequent D-PPDUs with reduced or excluded preamble formats. The indicator may signal any of the PPDU formats of FIG. 15, including option 1, option 2, option 3 and option 4.

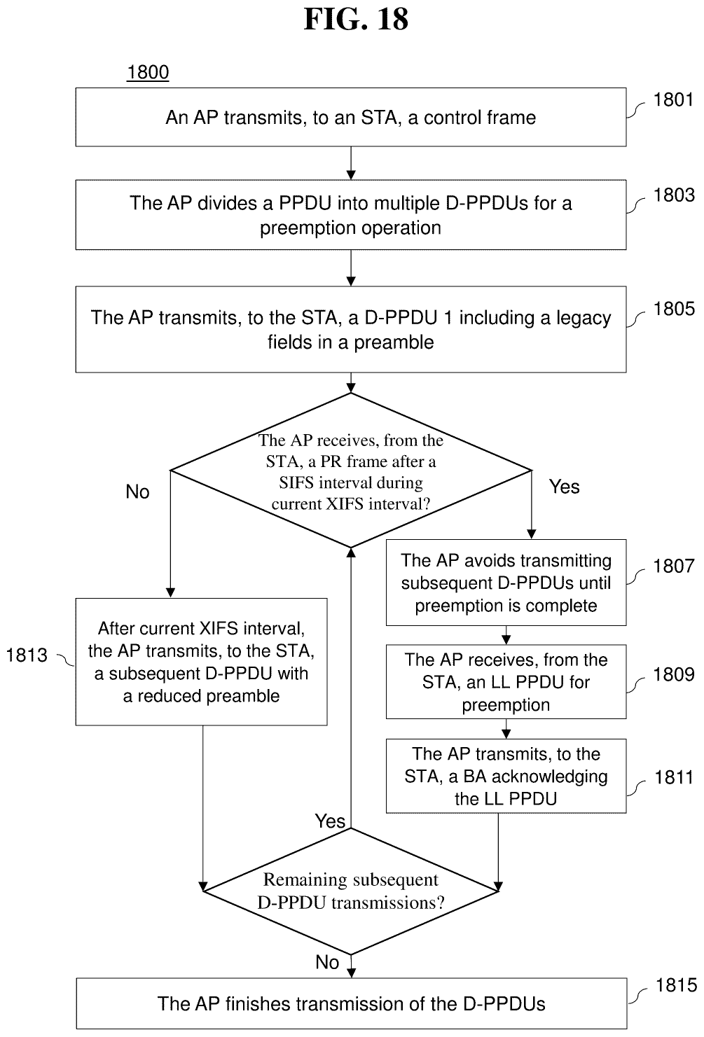

FIG. 18 shows an example process in accordance with an embodiment. The process depicted in FIG. 18 is for explanatory and illustration purposes. FIG. 18 does not limit the scope of this disclosure to any particular implementation.

Referring to FIG. 18, the process 1800 begins at operation 1801. In operation 1801, an AP transmits, to an STA, a control frame. The control frame may be an MU-RTS frame.

In operation 1803, the AP divides a PPDU into multiple D-PPDUs for preemption operation. The resulting D-PPDUs include a D-PPDU 1 and subsequent D-PPDUs where a portion of the data in the PPDU is in each D-PPDU. The subsequent D-PPDUs have a reduced preamble based on the PPDU formats as shown in FIG. 15.

In operation 1805, the AP transmits, to the STA, the D-PPDU 1 including legacy preamble fields in a preamble. The data field of the D-PPDU 1 is decodable by the STA based on an L-STF and an L-LTF of the legacy preamble fields. An L-SIG and RL-SIG of the legacy preamble fields indicate a period of time of a preemption operation or a TXOP. Operation 1805 is followed by operation 1807 if the AP receives, from the STA, a PR frame after an SIFs interval before the end of a current XIFS interval which is an IFS longer than an SIFS interval. Operation 1805 is followed by operation 1813 if the AP does not receive a PR frame during a current XIFS interval.

In operation 1807, the AP avoids transmitting subsequent D-PPDUs until preemption is complete.

In operation 1809, the AP receives, from the STA, an LL PPDU for preemption.

In operation 1811, the AP transmits, to the STA, a BA acknowledging the LL PPDU. Operation 1811 is followed by operation 1807 if there are remaining subsequent D-PPDU transmissions and the AP receives, from the STA, a PR frame after an SIFS interval before the end of a current XIFS interval. Operation 1811 is followed by operation 1813 if there are remaining subsequent D-PPDU transmissions and the AP does not receive a PR frame during the current interval. Operation 1811 is followed by operation 1815 if there are not remaining subsequent D-PPDU transmissions.

In operation 1813, after a current XIFS interval, the AP transmits, to the STA, a subsequent D-PPDU with a reduced preamble. Operation 1813 is followed by operation 1807 if there are remaining subsequent D-PPDU transmissions and the AP receives, from the STA, a PR frame after an SIFS interval during a current XIFS interval. Operation 1813 repeats if there are remaining subsequent D-PPDU transmissions and the AP does not receive a PR frame during the current interval. Operation 1813 is followed by operation 1815, if there are no remaining subsequent D-PPDU transmissions.

In operation 1815, the AP finishes transmission of the D-PPDUs and completes the TXOP.

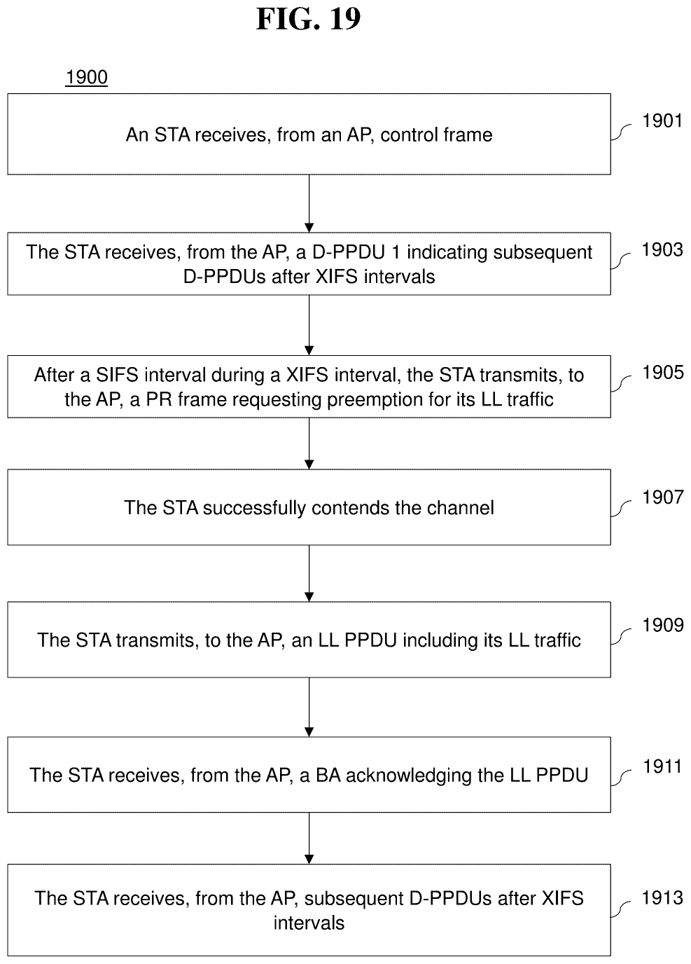

FIG. 19 shows another example process in accordance with an embodiment. The process depicted in FIG. 19 is for explanatory and illustration purposes. FIG. 19 does not limit the scope of this disclosure to any particular implementation.

Referring to FIG. 19, the process 1900 begins at operation 1901. In operation 1901, an STA receives, from an AP, a control frame. The control frame may be an MU-RTS frame.

In operation 1903, the STA receives, from the AP, a D-PPDU 1 indicating subsequent D-PPDUs after XIFS intervals which are IFS intervals longer than SIFS intervals. The STA can decode the D-PPDU 1 using the legacy preamble fields of the D-PPDU 1. The STA may decode an indication in D-PPDU 1 indicating that D-PPDU 1 is a D-PPDU and that there are subsequent D-PPDUs. The indication may also indicate a specific PPDU format of the subsequent D-PPDUs, including the PPDU formats of FIG. 15.

In operation 1905, after an SIFS interval before the end of a XIFS interval, the STA transmits, to the AP, a PR frame requesting preemption for its LL traffic. The PR frame may be transmitted after the D-PPDU 1 or after any subsequent D-PPDU.

In operation 1907, the STA successfully contends the channel for transmission of its LL traffic.

In operation 1909, the STA transmits, to the AP, an LL PPDU including its LL traffic.

In operation 1911, the STA receives, from the AP, a BA acknowledging the LL PPDU.

In operation 1913, the STA receives from the AP, subsequent D-PPDUs after XIFS intervals.

The disclosure provides mechanisms and procedures for performing preemption operation during the transmission of multiple D-PPDUs including PPDU formats with preambles excluding legacy preamble fields resulting in greater efficiency in the preemption operation with multiple D-PPDUs.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) for facilitating communication in a wireless network, comprising:
a memory; and
a processor coupled to the memory, the processor configured to cause:
obtaining a transmission opportunity (TXOP) on a wireless channel; and
transmitting, to a station (STA), a plurality of frames including a first frame and a second frame, wherein the second frame is transmitted after the first frame, the first frame including a first preamble and the second frame including a second preamble, wherein the second preamble has a shorter duration than the first preamble.

2. The AP of claim 1, wherein:
the first preamble includes one or more legacy preamble fields and one or more non-legacy preamble fields; and
the second preamble includes one or more non-legacy preamble fields.

3. The AP of claim 2, wherein the first preamble includes a legacy signal field indicating a duration of the TXOP.

4. The AP of claim 1, wherein a time interval between two consecutive frames of the plurality of frames is greater than a short interframe space (SIFS) interval.

5. The AP of claim 1, wherein the processor is further configured to cause:
receiving, from the STA, a request frame indicating a preemption request for transmission of low-latency traffic;
deferring transmission of a frame that is scheduled for transmission to the STA in response to receiving the request frame;
receiving, from the STA, a frame carrying low-latency traffic; and
transmitting the deferred frame after reception of the frame carrying the low-latency traffic is completed.

6. The AP of claim 5, wherein the deferred frame includes the first preamble.

7. The AP of claim 5, wherein the deferred frame includes the second preamble.

8. The AP of claim 5, wherein the AP receives the request frame indicating the preemption request after an SIFS interval following transmission of a frame scheduled for transmission prior to the deferred frame and before the transmission of the deferred frame.

9. A station (STA) for facilitating communication in a wireless network, comprising:
a memory; and
a processor coupled to the memory, the processor configured to cause:
receiving, from an access point (AP), a plurality of frames including a first frame and a second frame, wherein the second frame is received after the first frame, the first frame including a first preamble and the second frame including a second preamble, wherein the second preamble has a shorter duration than the first preamble.

10. The STA of claim 9, wherein:
the first preamble includes one or more legacy preamble fields and one or more non-legacy preamble fields; and
the second preamble includes one or more non-legacy preamble fields.

11. The STA of claim 10, wherein the first preamble includes a legacy signal field indicating a duration of a transmission opportunity (TXOP) on a wireless channel.

12. The STA of claim 9, wherein a time interval between two consecutive frames of the plurality of frames is greater than a short interframe space (SIFS) interval.

13. The STA of claim 9, wherein the processor is further configured to cause:
transmitting, to the AP, a request frame indicating a preemption request for transmission of low-latency traffic;
obtaining a wireless channel which the STA receives the plurality of frames on;
transmitting, to the AP, a frame carrying low-latency traffic; and
receiving, from the AP, a deferred frame after the transmission of the frame carrying the low-latency traffic is completed, wherein the deferred frame is scheduled for transmission to the STA and is deferred in response to the request frame.

14. The STA of claim 13, wherein the deferred frame includes the first preamble.

15. The STA of claim 13, wherein the deferred frame includes the second preamble.

16. The STA of claim 13, wherein the STA transmits the request frame indicating the preemption request after an SIFS interval following transmission of a frame scheduled for transmission prior to the deferred frame and before the transmission of the deferred frame.

17. A method performed by an access point (AP) in a wireless network, comprising:
obtaining a transmission opportunity (TXOP) on a wireless channel; and
transmitting, to a station (STA), a plurality of frames including a first frame and a second frame, wherein the second frame is transmitted after the first frame, the first frame including a first preamble and the second frame including a second preamble, wherein the second preamble has a shorter duration than the first preamble.

18. The method of claim 17, wherein a time interval between two consecutive frames of the plurality of frames is greater than a short interframe space (SIFS) interval.

19. The method of claim 1, further comprising:
receiving, from the STA, a request frame indicating a preemption request for transmission of low-latency traffic;
deferring transmission of a frame that is scheduled for transmission to the STA in response to receiving the request frame;
receiving, from the STA, a frame carrying low-latency traffic; and
transmitting the deferred frame after reception of the frame carrying the low-latency traffic is completed.

20. The method of claim 19, wherein the AP receives the request frame indicating the preemption request after an SIFS interval following transmission of a frame scheduled for transmission prior to the deferred frame and before the transmission of the deferred frame.
